(19) United States
(12) Patent Application Publication
(10) Pub. No.: US 2003/0130889 A1
(43) Pub. Date: Jul. 10, 2003

(54) System and method for electronically generating, clipping and redeeming coupons

(76) Inventor: Kevin D. Fravel, Bristol, PA (US)

Correspondence Address: ERIC LAMORTE, LAMORTE & ASSOCIATES, P.O. BOX 434, YARDLEY, PA, 19067, US

(21) Appl. No.: 10/041,959

(22) Filed: Jan. 10, 2002

(51) Int. Cl. G06F 17/60

(52) U.S. Cl. 705/14; 705/26

(57) ABSTRACT

A system and method of posting, clipping and redeeming electronic coupons is claimed. Electronic coupons are posted on a website by registered manufacturers. The coupons are selected by consumers who have coupon account cards. Once a product is selected at a retailer, the retailer links with a remote database to determine if a coupon is on the consumer's account for the product being purchased. If the appropriate electronic coupon is present, the coupon is honored by the retailer. The retailer then uses the same system to be reimbursed by the system using money from the accounts of the manufacturers that posted the coupon.

### BACKGROUND OF THE INVENTION

1. Field of the Invention

The present invention relates to systems and methods for generating, clipping and redeeming coupons via computer over the Internet. More particularly, the present invention relates to such systems and methods that enable consumers, retailers and manufacturers to use a common database source, accessible through the Internet, to post electronic coupons, clip electronic coupons and obtain coupon reimbursements.

2. Prior Art Statement

Coupons are used by manufacturers as a way to entice consumers to buy their products. Traditionally, coupons are printed in newspapers or other periodicals. The manufacturer pays the publication to carry the coupon. Upon seeing the coupon, a consumer cuts the coupon out of the periodical and takes the coupon to a retail store. At the retail store, the consumer buys the product that corresponds to the coupon and redeems the coupon at check out. Once redeemed, the value of the coupon is subtracted from the price of that object. The retailers then submit claims to the manufacturers for reimbursement or merchandise credit.

The use of traditional paper coupons generates several problems. One problem is that it takes a great deal of time and effort for people to search through various periodicals looking for coupons for the product they want to buy. Secondly, the organization, tracking and reimbursement process for coupon use is a complex, labor intensive, accounting endeavor for many retailers. Recognizing the faults of a paper-based coupon system, there have been attempts to automate the use of coupons. One prior art approach has been the use of websites where a person can print out various coupons. U.S. Pat. No. 6,035,280 to Christensen, entitled Electronic Discount Couponing Method And Apparatus For Generating An Electronic List Of Coupons, and U.S. Pat. No. 5,907,830 to Engel, entitled Electronic Coupon Distribution, exemplify such systems. Although these patents help a consumer locate coupons, these systems do nothing to alleviate the bookkeeping problems of a retailer trying to get reimbursed for the coupons.

In the prior art, systems have been developed where paper coupons are eliminated altogether. In such systems, consumers are given specialized cards. Using a card writing device and specialized software, a consumer can download selected coupons onto the card. The coupons are then downloaded from the card at the retailer. Such systems are exemplified by U.S. Pat. No. 6,055,509 to Powell, entitled System And Method For Transferring Identification Information Between Portable Cards In A Computerized Retail Store Having Communication Among A Plurality Of Computers, and U.S. Pat. No. 6,012,038 to Powell, entitled System And Method For Controlling Distribution Of Coupons. Since such systems require a capital investment of specialized card writing equipment and software, such systems are not well suited for use by a wide segment of the population.

A need therefore exists for a system and method of selecting, clipping and redeeming coupons that is paperless, and requires no specialized hardware or software to be purchased by either the consumer, retailer or manufacturer. This need is met by the present invention as described and claimed below.

### SUMMARY OF THE INVENTION

The present invention is a system and method for posting, clipping and reimbursing electronic coupons. The system requires that all participating consumers, manufacturers and retailers register their participation in the system. Once registered, consumers are given coupon cards. A website is established where consumers can search for and select electronic coupons. Once a consumer selects a coupon, that coupon is placed in an electronic account for that consumer. It is this electronic account that is identified by the coupon card.

Registered manufacturers are able to post electronic coupons on the system's website. The manufacturers are charged for the type of electronic coupon posted and the number of system users that select that coupon within a given billing period.

The consumer's coupon card is presented to a cashier when buying a product from a retailer. The coupon card is scanned and a telecommunications link is established between the system's consumer account database and the retailer. Information is exchanged concerning the consumer's account. Once the consumer is identified, data regarding previously selected electronic coupons is transferred to the retailer. The cash register at the retailer compares the electronic coupon data with the products being bought. If one or more coupons are applicable, the coupons values are honored and deducted from the price.

The electronic coupons redeemed by a retailer can be reimbursed using the same system. Information regarding redeemed electronic coupons is transmitted to the system. The system then reimburses the retailers from the active accounts of the registered manufacturers.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic of the overall electronic coupon system in accordance with the present invention;

FIG. 2 is a block diagram logic flow illustrating a consumer's use of the present invention system;

FIG. 3 is a block diagram logic flow illustrating some sub-steps used in the logic of FIG. 2;

FIG. 4 is a block diagram logic flow illustrating a manufacturer's use of the present invention system; and

FIG. 5 is a block diagram logic flow illustrating a retailer's use of the present invention system.

### DETAILED DESCRIPTION OF THE INVENTION

Although the present invention system and method can be used to post, clip and redeem any type of coupon, the system and method are especially useful in posting, clipping and redeeming grocery coupons. As such, by way of example, the present invention system and method will be described in an application where it is used to post, clip and redeem coupons for use at a grocery store, in order to present the best mode contemplated for the invention.

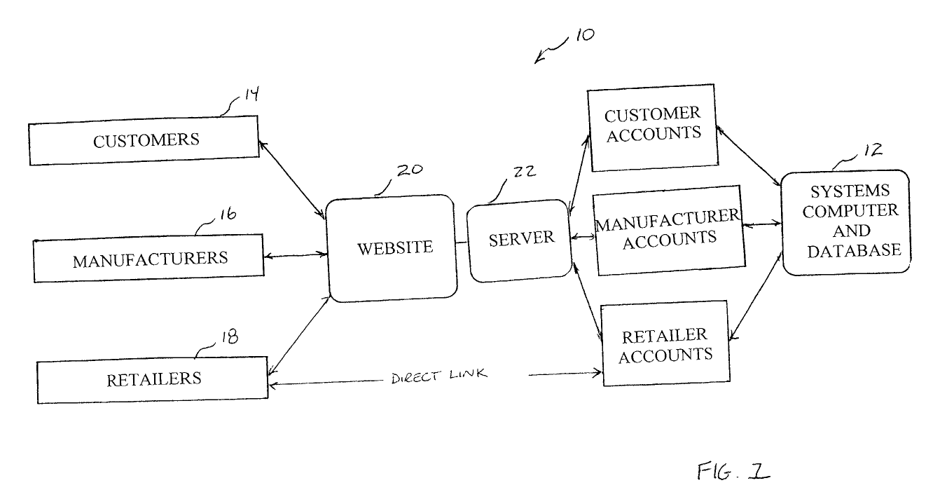

Referring to FIG. 1, a schematic of the overall system 10 is shown. The system 10 includes a central computer and database 12 located at at least one processing center. The processing center can be located anywhere in the country. Consumers 14, manufacturers 16 and retailers 18 all access the central computer and database 12 via telecommunication links. As will be explained, the telecommunication links are preferably directed through a website 20 on the internet. Wherein a server 22 hosts the website 20. The central computer and database 12 communicates with the server using conventional telecommunications equipment.

Access to the central computer and database 12 is governed by the use of account numbers. Accordingly, all consumers 14, manufacturers 16 and retailers 18 must establish accounts with the central computer and database 12, prior to the use of the system.

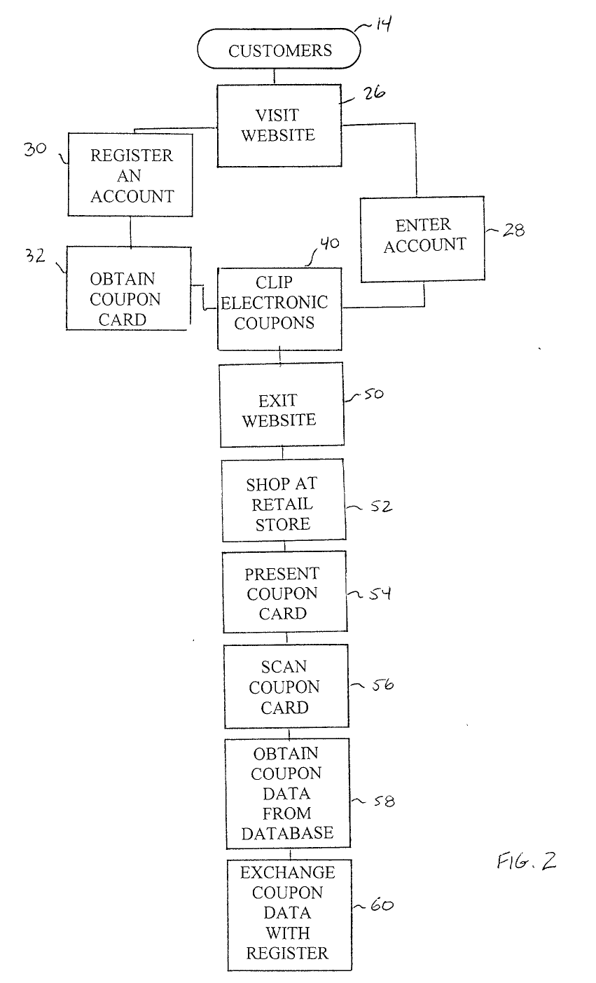

Referring to FIG. 2, it can be seen that in order for consumers 14 to use the present invention system 10, consumers 14 use computers and the Internet to visit the system's website 20. The accessing of the website over the Internet is shown as Block 26. Once at the website, consumers 14 are prompted to see if the consumers 14 are registered as systems users and have the appropriate account numbers. As is indicated by Block 28, if a consumer has an account number, that account number is entered. In addition to the account number, a user may also be given a password, so that imposters cannot use the system.

As is indicated by Block 30, if a consumer is not registered as a user, the website will query the consumer for needed information, such as name, address, etc., and will register the user. Once registered, consumers will be given account numbers. Users can also register via the mail or by telephone. Once a consumer is registered, that consumer is sent a coupon account card. (See Block 32) The coupon account card is a card with a magnetic strip or other electronic storage device that stores the consumer's account number. As such, every consumer registered to use the system is given an account number and a coupon account card that contains that account number.

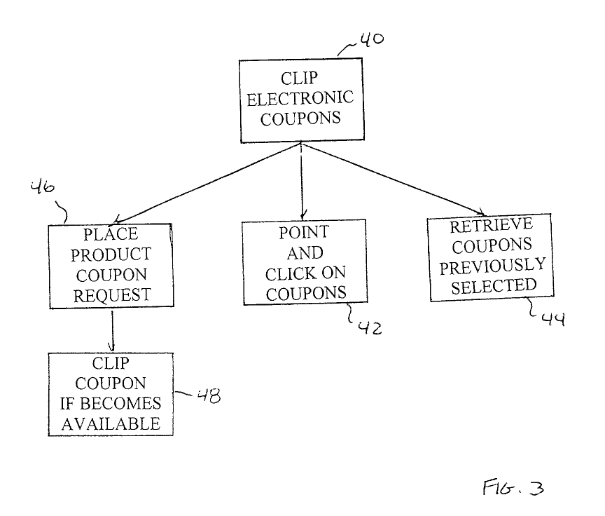

Once a consumer has a coupon account card and visits the system's website, a consumer enters his/her account number and can begin to shop for coupons. By navigating through the website, coupons in various categories for various products in each category will be presented. Block 40 in FIG. 2 shows the step of electronically clipping coupons. However, by referring briefly to FIG. 3, it can be seen that the step of electronically clipping coupons 40 (FIG. 2) can have sub-steps. As is indicated by Block 42, coupons can be selected simply by pointing and clicking on the desired coupon using a computer cursor. However, the software run at the website can store data on you past coupon selection habits. Previously selected coupons can be automatically added to the consumer's selected coupon list, as is indicated by Block 44. Furthermore, a consumer can request a coupon for a specific product that the consumer wants to buy. (See Block 46) If a coupon does appear for this product, in the future, that coupon can automatically be added to the consumer's account. (See Block 48) The consumer will be alerted to the appearance of the requested coupon the next time that consumer visits the website.

Returning to FIG. 2, it can be seen that after a consumer selects the desired coupons, the consumer exits the website. (See Block 50) When a consumer checks out of the website, the coupons selected by the consumer are stored under that consumer's account number. Referring to Block 52, it can be seen that the consumer then goes to shop at his/her favorite retail store. Upon checkout at the store, the consumer presents the cashier with the coupon account card. (See Block 54) The cashier runs the coupon account card through a card reading device. (See Block 56) Many card reading devices are already present at cashier stations to serve patrons who pay using credit cards or debit cards. These card reading devices are interfaced with the cashier's register so that debit and credit payments can be directly recognized by the cashier's register. If a person forgets his/her card, the customer may present his/her account number orally. Alternatively, the retailer may keep a list of its customer's account numbers that can be accessed at any time upon request by a customer.

With the present invention system, the card reading device is programmed with software that accesses the central database and processing center. Once accessed, the consumer's account number is sent to the central computer and database and the data regarding the coupons previously selected by the consumer is downloaded. Block 58 shows the step of obtaining the coupon data from the central database. The card reading machine receives the coupon data from the consumer's account and transfers that data to the cashier's register. As is indicated by Block 60, the cashier's register compares the coupon data to the products purchased and reduces the price of the appropriate products by the coupon value. Many modern cashiers' registers already have the ability to read coupon data, compare coupon data to purchased items and deduct coupon values appropriately. Consequently, the programming of the cashier's registers need not be changed.

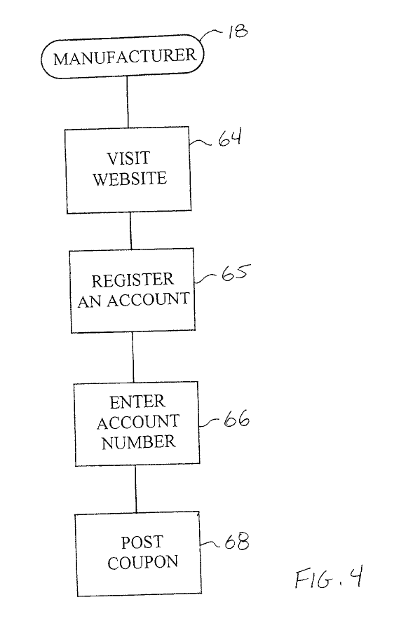

The present invention system, as used by manufacturers, is used to post coupons rather than to electronically clip coupons. Referring to FIG. 4, it can be seen that a manufacturer desiring to post a coupon accesses the website for the central computer and database. (See Block 64) The website can be the same website that is used by consumers, or can be a second dedicated website just for manufacturers. Once a manufacturer is at the website, the manufacturer must first open an account with the system and obtain an account number. (See Block 64) Once an account number is obtained, the account number is used to access the manufacturer's section of the website. (See Block 66) After the account number has been accepted at the website, a manufacturer can post a coupon. (See Block 68) Multiple types of postings will be offered. Standard postings will cost the manufacturer one price. Banner postings or pop-up postings will be offered at a higher price. The manufacturer enters how long a certain posted coupon is valid. The coupon is automatically removed from the website when the coupon expires. In this manner, any consumer clipping coupons from the website knows that all the posted coupons are valid.

Manufacturers can post coupons predesigned by the manufacturers. However, software will be provided through the website that enables a manufacturer to create a coupon directly at the website.

The manufacturer can be charged for posting the coupon. However, in a preferred embodiment, the present invention system monitors how many times a manufacturer's coupon is clipped by a consumer. The price charged to the manufacturer is dependent upon how many times that manufacturer's coupon is clipped by consumers. Consequently, a manufacturer is not forced to pay for any coupon advertising that is not selected by consumers.

Retailers can post their own coupons in the same manner that manufacturers post coupons. However, retailers will mostly use the present invention system to obtain reimbursement for the coupons used by consumers in their stores.

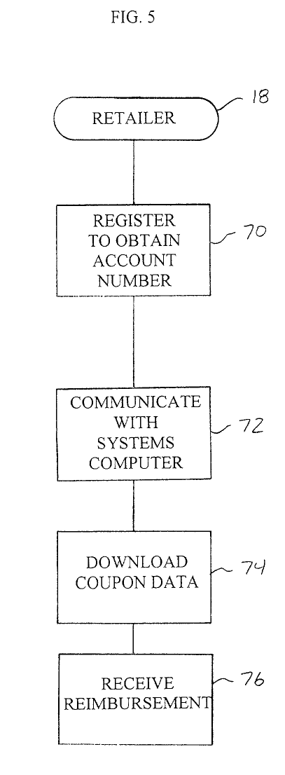

Referring to FIG. 5, it can be seen that retailers register and are assigned account numbers. (See Block 70) At periodic times, a retailer establishes a telecommunications link with the central database and processing center. (See Block 72) This can be done directly over a direct telephone link, or can be done over a personal computer through the website. Alternatively, it will be understood, that each time a consumer uses his/her coupon account card at a retailer, a link is created between the card reading machine at the retailer and the central computer and database. This link can also be used to download coupon data on the coupons that have been redeemed by that consumer during a particular sale. As is indicated by Block 74, once a link is established between the retailer and the central computer and database, the retailer downloads information regarding the coupons that have been redeemed at that retail store. The coupon data can be downloaded in batches or can be downloaded for each consumer at the time of that sale.

Referring to Block 76, it can be seen that after the central computer and database receives information from a retailer regarding coupons that have been redeemed, the central computer and database then automatically generates the proper reimbursement to the retailer. The reimbursement is taken directly from the funds paid into the system by the manufacturers.

Returning now to FIG. 1, it will be understood that the present invention system provides a way for consumers to electronically clip coupons and redeem those coupons at a retailer. The same system also enables manufacturers to post coupons and retailers to be reimbursed for redeemed coupons using the same system. The system is paperless. Furthermore, the system requires only that consumers obtain coupon account cards and that retailers update their card reader programs to read the coupon account cards. No expensive hardware or software needs to be purchased by any party.

It will be understood that the system and method of the present invention described and illustrated are merely exemplary and a person skilled in the art can make many variations to the shown embodiment. All such alternate embodiments and modifications are intended to be included within the scope of the present invention as defined below in the claims.

What is claimed is:

1. A method, comprising the steps of:
providing a database;
registering manufacturers who provide coupons for their manufactured goods in said database, wherein each registered manufacturer is provided with a manufacturer's account;
registering retailers who sell said manufactured goods in said database, wherein each registered retailer is provided with a retailer's account;
registering consumers who may buy said manufactured goods in said database, wherein each registered consumer is provided with a numbered consumer account and an account card that contains said numbered consumer account;
providing a website where said registered manufacturers can post coupons and said registered consumers can select coupons, wherein said coupons selected by said registered consumers are assigned to consumer accounts for those consumers in said database;
establishing a telecommunications link between a registered retailer and said database when a registered consumer purchases a product at a registered retailer and submits said account card at checkout, wherein data is exchanged through said link that determines if the consumer has previously selected a coupon for said product at said website; and
discounting said product at the registered retailer by said coupon if said coupon is present in the consumer account for that consumer.

2. The method according to claim 1, wherein said step of establishing a telecommunications link includes providing a card reading machine at each of said registered retailers, wherein each said card reading machine reads a consumer account from said account card and queries said database regarding selected coupons in that consumer account.

3. The method according to claim 1, further including the step of charging each registered manufacturer who posts a coupon on said website.

4. The method according to claim 3, wherein said step of charging each registered manufacturer includes charging each registered manufacturer a fee proportional to how many coupons posted by that registered manufacturer are selected by consumers.

5. The method according to claim 1, further including the step of reimbursing registered retailers for coupons redeemed using consumer account cards.

6. A method comprising the steps of:
providing a website where manufacturers can post electronic coupons and consumers can select posted electronic coupons;
providing a database that stores electronic coupons selected by consumers;
establishing a telecommunications link between a retailer and said database when a consumer purchases a product from that retailer;
downloading data regarding an electronic coupon selected by a consumer from said database to said retailer over said link if said consumer is purchasing a product for which said consumer has previously selected an electronic coupon at said website, wherein said retailer can honor said coupon.

7. The method according to claim 6, further including the step of registering consumers who want to select electronic coupons from said website and providing each registered consumer with a card.

8. The method according to claim 7, wherein said step of establishing a telecommunications link includes the sub-steps of:
providing a card reading machine capable of exchanging data with said database; and
scanning said card of a consumer through said card reading machine.

9. The method according to claim 8, wherein said step of downloading data includes the sub-steps of:
downloading data regarding an electronic coupon to said card reading machine;
exchanging said data between said card reading machine and a cash register; and
comparing said coupon to products being purchased by a consumer;
deducting a coupon value if a coupon corresponds to a product being purchased.

10. The method according to claim 6, further including the step of charging each manufacturer who posts a coupon on said website.

11. The method according to claim 10, wherein said step of charging each manufacturer includes charging each manufacturer a fee proportional to how many coupons posted by that manufacturer are selected by consumers.

12. The method according to claim 6, further including the step of reimbursing retailers for coupons redeemed.

13. The method according to claim 6, further including the step of registering manufacturers who provide coupons for their products in said database, wherein each registered manufacturer is provided with a manufacturer's account and enabling only registered manufactures to post electronic coupons at said website.

14. The method according to claim 13, further including the step of registering retailers who sell said products of said registered manufacturers, wherein each registered retailer is provided with a retailer's account and enabling only registered retailers the ability to redeem said electronic coupons.

15. The method according to claim 13, further including the step of registering consumers, wherein each registered consumer is provided with a numbered consumer account and an account card that contains said numbered consumer account.
